(19) United States
(12) Patent Application Publication
(10) Pub. No.: US 2026/0131324 A1
(43) Pub. Date: May 14, 2026

(54) A CONTAINER FOR IN VITRO DRUG TESTING

(71) Applicants: National University of Singapore, Singapore (SG); SOTAX AG, Aesch (CH)

(72) Inventors: Matthias Wacker, Singapore (SG); David Li, Singapore (SG); Michel Magnier, Aesch (CH); Gilles Kalbermatten, Aesch (CH)

(21) Appl. No.: 19/120,420

(22) PCT Filed: Oct. 11, 2023
(86) PCT No.: PCT/SG2023/050686

§ 371 Date: Apr. 11, 2025

(30) Foreign Application Priority Data
Oct. 13, 2022 (SG) 10202251372B

(51) Int. Cl. B01L 3/00

(52) U.S. Cl. CPC B01L 3/502; B01L 2200/0689; B01L 2200/12; B01L 2300/042; B01L 2300/12

(57) ABSTRACT

The present disclosure relates to a container for in vitro drug testing. The container comprises a receptacle having a wall made of a gel composition. The receptacle has an opening and is configured to receive a drug formulation through the opening. The gel composition is selected to simulate one or more properties of tissue.

### FIELD OF INVENTION

The present disclosure relates broadly, but not exclusively, to a container for in vitro drug testing, a method for preparing the container, a test apparatus comprising the container and a testing method.

### BACKGROUND

Administering drugs extravascularly including, for instance, muscle or subcutaneous tissues, is a quick and patient-friendly method for delivering pharmaceutical substances into the human body that requires minimal supervision from healthcare professionals. For many formulations administered using these administration routes, the bioavailability largely depends on several factors such as their diffusion behaviour. Hence, during the development process, it is crucial to test them to determine their performance. While animal testing remains the ultimate tool to compare formulations, in vitro testing presents a more rapid and cost-effective alternative.

In vitro performance assays are one of the evaluation techniques for gaining essential information on the bioavailability and other preclinically relevant characteristics of pharmaceutical substances and dosage forms by using a controlled in vitro environment, rather than a living organism. This approach has the potential to reduce the number of costly and time-consuming animal and human trials. However, in vitro performance assays designed for extravascular dosage forms including those for subcutaneous or intramuscular administration face several challenges due to the absence of established standards. Additionally, there is a notable deficiency in emphasizing feasibility and quality control testing, hindering the development of reliable methods for assessing the bioavailability of pharmaceutical substances.

One such in vitro performance assay involves using a dispersion releaser (DR), which utilises a biorelevant media to mimic interstitial fluid in the subcutaneous tissue and a dialysis-based setup for analysing drug release. However, this method cannot mimic certain aspects of the physiological environment that may influence the performance of pharmaceutical substances and dosage forms. These factors can include biorelevant diffusion, tissue retention, and hydrodynamics. This may affect the reliability and predictive power of the test results.

Another in vitro performance assay involves using an instrument called the Subcutaneous Injection Site Simulator N3 (SCISSOR N3). The SCISSOR N3 instrument utilises an injection cartridge filled with hyaluronic acid (HA) acting as the donor medium. This cartridge is separated from a surrounding acceptor medium with a membrane. This setup attempts to mimic the microenvironment of the extracellular matrix that provides diffusional resistance with the viscous HA. However, the system does not comply with international standards important for the regulation of medicines. Such technical standards are, for example, provided by the national pharmacopeias which provide a harmonized structure for the testing of medicines. Additionally, the instrument is rather costly for such a highly specialised equipment and does not allow the in vitro environment to be flexibly changed, e.g., by changing flow or stirring rates.

Other in vitro performance assays have also utilised laboratory apparatus or tools, such as shake-flask and continuous flow-through cells, or materials like hydrogels to mimic the conditions within tissues. However, despite the exciting alternatives and opportunities that subcutaneous formulations offer for existing and future pharmaceutical substances, there is a lack of suitable in vitro models capable of reliably and quickly predicting the bioavailability of these substances in the human body that follow a well-structured technical framework.

A need therefore exists to provide an apparatus that seeks to address the problems above or to provide a useful alternative.

### SUMMARY

According to a first aspect of the present invention, there is provided a container for in vitro drug testing, the container comprising:
a receptacle having a wall, wherein the receptacle has an opening and is configured to receive a drug formulation through the opening, and wherein the wall is made of a gel composition.

A concentration of the gel composition may be selected to simulate one or more properties of tissue.

The gel composition may comprise one or more polysaccharides selected from a group consisting of agarose and hyaluronic acid.

The gel composition may comprise 0-5% by weight of agarose gel.

The gel composition may comprise 0-3% by weight of hyaluronic acid.

The gel composition may comprise one or more polypeptides selected from a group consisting of collagen, gelatine and peptone.

The gel composition may comprise 0-1% by weight of collagen.

The gel composition may comprise 0-5% by weight of gelatine.

The gel composition may comprise one or more lipids selected from triglycerides and phospholipids.

The gel composition may comprise ions.

The gel composition may comprise vesicles.

The gel composition may comprise serum proteins.

The container may further comprise a plug for sealing the opening of the receptacle.

The container may further comprise a ring encircling a periphery of the opening of the receptacle for an injection of the drug formulation into the receptacle.

The ring may be made of a chemically inert material.

The chemically inert material may comprise a polymer or a metal.

The ring may comprise a collar encircling its inner wall adjacent a base of the ring, creating a recess to accommodate the periphery of the opening of the receptacle.

The ring may comprise a textured area encircling its inner wall adjacent a top of the ring.

According to a second aspect of the present invention, there is provided a method for preparing a container for in vitro drug testing, the method comprising the steps of: forming a receptacle having a wall, wherein the wall is made of a gel composition; and disposing a drug formulation into the receptacle.

Forming a receptacle having a wall may comprise the steps of:
attaching a ring to a mould;
pouring the gel composition into the mould; and
inserting an inner punch to the gel composition to form the receptacle such that the ring encircles a periphery of the opening of the receptacle.

According to a third aspect of the present invention, there is provided a test apparatus comprising the container as defined in the first aspect.

According to a fourth aspect of the present invention, there is provided a testing method comprising:
disposing a drug formulation in the container as defined in the first aspect;
immersing the container into a media inside a US pharmacopeia (USP) IV flow-through cell; and
monitoring diffusion of the drug formulation between the container and the media

### BRIEF DESCRIPTION OF THE DRAWINGS

Embodiments of the invention are provided by way of example only, and will be better understood and readily apparent to one of ordinary skill in the art from the following written description and the drawings, in which:

FIG. 1A illustrates a schematic diagram showing a container for in vitro drug testing in accordance with an example embodiment.

FIG. 1B illustrates a photograph of the container shown in FIG. 1A.

FIG. 1C illustrates a top view (left) and a bottom view (right) of the ring shown in FIGS. 1A and 1B.

FIG. 2 illustrates a schematic diagram showing a modified flow-through cell including a container in accordance with another example embodiment.

FIG. 3 illustrates two flow charts, each depicting a breakdown of diffusion experiments conducted for an individual version of hydrogel-based diffusion containers.

FIG. 4A illustrates a hydrogel container (left) and a modified flow-through cell (right), used as a proof-of-concept model for the diffusion experiment shown in the first flow chart of FIG. 3.

FIG. 4B illustrates an assay setup for the proof-of-concept model of FIG. 4A for in vitro drug testing.

FIG. 5 illustrates an assay setup of the hydrogel container in the USP apparatus IV for the diffusion experiment shown in the second flow chart of FIG. 3.

FIG. 6A illustrates a line graph depicting the diffusion profile of Actrapid® and Apidra® in the experiment explained with reference to FIGS. 4A and 4B.

FIG. 6B illustrates a line graph depicting the outcome of the reference experiment explained with reference to FIGS. 4A and 4B.

FIG. 7A illustrates a line graph depicting the diffusion profile of a caffeine stock solution in the experiment explained with reference to FIG. 5.

FIG. 7B illustrates a line graph depicting the diffusion profile of Actrapid® and Apidra® in PBS solution in the experiment explained with reference to FIG. 5.

FIG. 7C illustrates a line graph depicting the diffusion profile of Actrapid® and Apidra® in SIB solution in the experiment explained with reference to FIG. 5.

FIG. 7D illustrates a line graph depicting the outcome of the reference experiment explained with reference to FIG. 5.

FIG. 7E illustrates a line graph depicting the diffusion profile of Insulatard® and Insulatard® treated with heparin in PBS solution in the experiment explained with reference to FIG. 5.

### DETAILED DESCRIPTION

The present invention relates to a container, which serves as a release and diffusion adapter, for the in vitro testing of drug formulations intended for subcutaneous administration. The container includes a receptacle with an opening, and a plug for sealing the opening of the receptacle. The container may also include a ring encircling a periphery of the opening of the receptacle to act as an injection port for administering drug formulations into the receptacle. In use, the container is integrated into a flow-through cell of a United States Pharmacopeia (USP) apparatus IV.

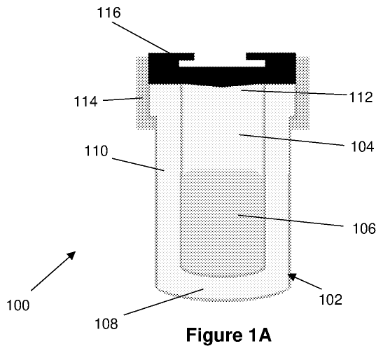

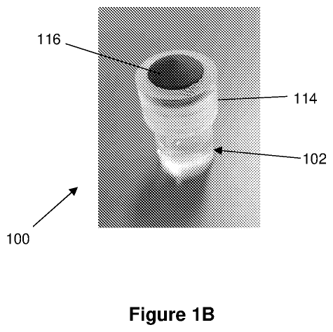

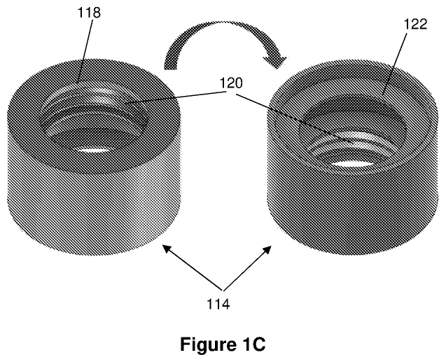

FIG. 1A illustrates a schematic diagram showing a container 100 for in vitro drug testing in accordance with an example embodiment. FIG. 1B illustrates a photograph of the container 100 shown in FIG. 1A. The dimensions of the container 100 are approximately 40 mm in height and 19 mm in width. The container 100 includes a receptacle 102 having an elongated cylindrical body with a consistent radius that forms an interior pocket 104 for holding a drug formulation 106. The receptacle 102 has a bottom wall 108 as its base, and a side wall 110 surrounding the bottom wall 108 and extends from the bottom wall 108 to an opening 112 at the upper end of the side wall 110. These walls 108, 110 have a thickness of approximately 2.5 mm and act as a barrier between the drug formulation 106 and the media in the flow-through cell.

The bottom wall 108 and side wall 110 of the receptacle 102 are made of a gel composition with its concentration selected to simulate one or more properties of tissue. The three-dimensional porous structure of the walls 108, 110 simulates the properties of subcutaneous tissue and acts as a diffusional resistance and membrane. In an embodiment, the gel composition includes one or more polysaccharides, such as agarose, hyaluronic acid or others. For example, the gel composition may include a concentration of 0-5% by weight of agarose gel and/or a concentration of 0-3% by weight of hyaluronic acid. For use in the USP apparatus IV, a slightly increased agarose concentration of approximately 3% can be selected to increase the gel firmness, allowing it to withstand the elevated shear forces inside the flow-through cell. The gel composition may further include ions, vesicles and/or serum proteins.

In another embodiment, the gel composition includes one or more polypeptides, such as collagen, gelatine and peptone. For example, the gel composition may include a concentration of 0-1% by weight of collagen and/or 0-5% by weight of gelatine. In yet another embodiment, the gel composition includes one or more lipids selected from triglycerides and phospholipids.

The container 100 further includes a ring 114 encircling a periphery of the opening 112 of the receptacle 102. The top of the ring 114 includes an opening to allow the drug formulation 106 to be injected into the interior pocket 104 of the receptacle 102. Additionally, the container 100 includes a plug 116 that is designed to seal the opening of the ring 114 after the drug formulation 106 has been injected into the interior pocket 104 of the receptacle 102, effectively sealing the opening 112 of the receptacle 102. In an embodiment, the plug 116 is made of rubber material for a secure seal.

In the example embodiment described in FIGS. 1A and 1B, the container 100 is used for in vitro testing of subcutaneously administered small-molecule drugs. In alternate embodiments, the container 100 can also be used for the testing of biological molecules, such as proteins, peptides or nucleic acids.

In the example embodiment described in FIGS. 1A and 1B, the receptacle 102 has an elongated cylindrical body and a rounded base. It will be appreciated by a person skilled in the art that the receptacle 102 may have different shapes, such as cube, sphere, oval, etc.

In the example embodiment described in FIGS. 1A and 1B, the bottom wall 108 and side wall 110 of the receptacle 102 are constructed entirely from a gel composition. In alternate embodiments, only a portion of the receptacle 102 is made of a gel composition to allow the diffusion of drug formulations, and the remaining portion can be made of other materials. For example, a portion of the base of the receptacle 102 is made of gel composition, and the remaining portion is made of an impermeable material. In another example, the side wall 110 is made of gel composition, while the bottom wall 108 is made of an impermeable material.

In the example embodiment described in FIGS. 1A and 1B, the container 100 includes a ring 114 encircling the periphery of the opening 112 of the receptacle 102. In an alternate embodiment, the container 100 may be constructed without a ring. In that case, the plug 116 is directly attached to the opening 112 of the receptacle 102 to seal it.

In the example embodiments described in FIGS. 1A and 1B, the container 100 is created for integration into the USP apparatus IV. In alternate embodiments, the container 100 may be created for use in other equipment, such as the USP apparatus II, Dispersion Releaser, extraction cell, etc.

FIG. 1C illustrates a top view (left) and a bottom view (right) of the ring 114 shown in FIGS. 1A and 1B. As shown in the top view, the top of the ring 114 has an opening 118 through which the liquid gel composition can be filled into a mould to form the receptacle 102 during the preparation process of the container 100. This opening 118 of the ring 114 also serves as an injection port, allowing the drug formulation 106 to be injected into the interior pocket 104 of the receptacle 102.

The ring 114 has several ridges 120 encircling the inner wall of the ring 114 adjacent its top. The ridges 120 provides a secure grip on the plug 116, preventing the plug 116 from dislocating. As shown in the bottom view, the ring 114 has a collar 122 encircling the inner wall of the ring 114 adjacent its base. The collar 122 creates a recess for the liquid gel composition to fit into. In other words, the recess offers additional space for accommodating the periphery of the opening 112 of the receptacle 102 once the gel composition hardens, thereby securing the ring 114 onto the receptacle 102. In an embodiment, the ring 114 is made of a chemically inert material, such as polymer or metal.

During the preparation process of the container 100, the ring 114 is mounted onto a mould. The liquid gel composition is poured into the mould through the opening 118 on top of the ring 114. An inner punch is inserted into the gel composition through the opening 118 of the ring 114 to create an interior pocket 104, forming the receptacle 102 with the ring 114 encircling the periphery of the opening 112 of the receptacle 102. During the preparation of the container 100 for in vitro drug testing, the drug formulation 106 is injected into the receptacle 102 through the opening 118 of the ring 114, followed by sealing the opening 118 of the ring 114 with the plug 116, thereby sealing the opening 112 of the receptacle 102.

In the example embodiment described in FIG. 1C, the ring 114 has several ridges 120 encircling the inner wall of the ring 114 adjacent its top. In alternate embodiments, the ring 114 may have other textured features to provide a good grip, such as threaded patterns, embossment, knurled surfaces, etc.

The present disclosure presents a novel in vitro test methodology that employs tissue-like matrices as diffusion barriers, in conjunction with the well-established USP apparatus IV, to emulate specific characteristics of the subcutaneous microenvironment. This innovative approach provides a validated, reproducible, discriminatory, and biopredictive, and standardized setup for evaluating current and future subcutaneous formulations. Crucially, the methodology incorporates the utilisation of the hydrogel container 100, which facilitates accurate assessment of diffusion behaviour of drug formulations. This correlation enables the prediction of their in vivo performance.

In use, the container 100 serves as a physicochemical barrier to the diffusion of the drug formulation that, because of the specifics of the set-up with a continuous flow of media perfusing the gel matrix, can be used to distinguish between drug formulations. Additionally, this set-up can be used to distinguish between drug formulations based on their diffusion and binding affinities to this matrix, rather than solely based on their dissolution behaviour, which can largely impact their absorption from the subcutaneous tissue. The set-up also significantly reduces the consumption of accessible media during in vitro drug testing, in comparison to assays where the formulation is directly injected into the bulk media. This mimics the reduced direct availability of fluids inside the subcutaneous tissue.

The dimensions of the container 100 is aligned with the size of the USP apparatus IV. This advantageously enables performance testing in a well-defined and harmonized environment for broader application in drugs and biological molecules. The gel composition used for making the receptacle 102 is customizable and can be prepared in a simple moulding process. Hence, the biorelevance of the container 100 can be adjusted to ensure feasibility and biopredictiveness of the assay. It also allows a full enclosure of the drug formulation inside the container 100, avoiding leakage of the drug and direct media contact. Additionally, the ring 114 is a simple and reusable holder that allows convenient injection of drug formulations using the original injection system provided by the manufacturer.

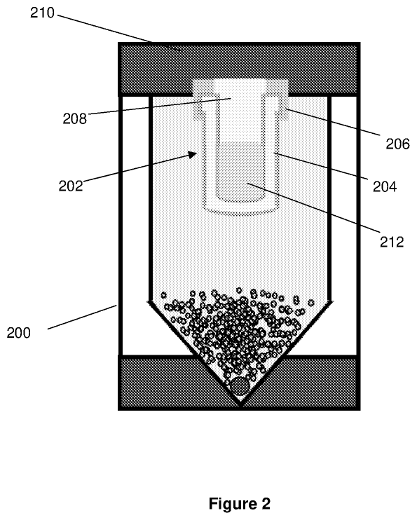

FIG. 2 illustrates a schematic diagram showing a modified flow-through cell 200 including a container 202 in accordance with another example embodiment. The container 202 includes a receptacle 204 made of a gel composition and a ring 206 encircling a periphery of the opening 208 of the receptacle 204. In contrast with the container described above with reference to FIGS. 1A and 1B, the container 202 in this embodiment does not have a plug. The ring 206 is configured to attach to the cap 210 of a modified flow-through cell 200. Accordingly, the opening of the ring 208 is inside the modified flow-through cell 200 and does not face the surrounding media. This may effectively eliminate the use of a plug, also allowing the drug formulation 212 to be injected into or drawn from the receptacle 204 through the modified flow-through cell 200 throughout the experiment.

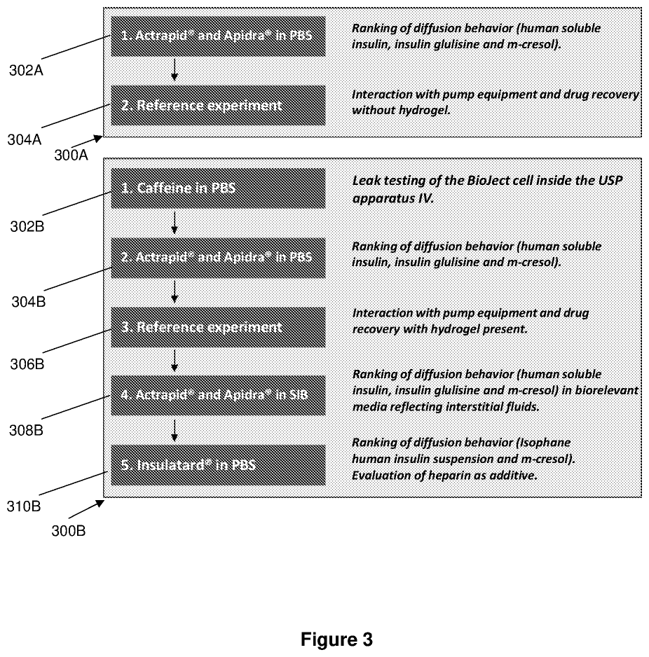

FIG. 3 illustrates two flow charts 300A, 300B, each depicting a breakdown of diffusion experiments conducted for an individual version of hydrogel-based diffusion containers.

For the diffusion experiments, various insulin formulations were selected as model drugs to test and compare their diffusion behaviour (Actrapid®, Apidra®, Insulatard®) in vitro. For this, normal, rapid and long-acting insulins were considered. m-Cresol, a common preservative present in insulin formulations was monitored as a small-molecular reference molecule and measured throughout the experiments alongside the insulin formulations. Table 1 below summarizes the composition and properties of the investigated drug products.

TABLE 1

| Drug | API (100 U/mL | | |
|---|---|---|---|
| formulation | or 3.5 mg/mL) | Composition | Description |
| Actrapid ® | Human soluble insulin | m-Cresol, ZnCl₂, glycerol, | Hexameric, normal |
| | | HCl, NaOH, water for | insulin |
| | | injections | |
| Apidra ® | Insulin glulisine | m-Cresol, NaCl, | Monomeric, rapid- |
| | | trometamol, polysorbate | acting recombinant |
| | | 20, HCl, NaOH, water for | insulin analogue |
| | | injections | |
| Insulatard ® | Isophane human insulin | m-Cresol, phenol, ZnCl₂, | Precipitated, long- |
| | suspension | glycerol, Na₂HPO₄•2H₂O, | acting insulin |
| | | protamine sulfate, HCl, | |
| | | NaOH, water for injections | |

Throughout the experiments, the diffusion of insulin and m-cresol through agarose hydrogels in phosphate-buffered saline (PBS) was monitored. m-Cresol was expected to diffuse more rapidly compared to the peptides. It reaches a plateau after a few hours and can be used to monitor intercell-variability and the integrity of the hydrogel. Caffeine has been selected as a second diffusion marker to serve a similar purpose as the m-cresol. These two molecular entities that exhibit differences in their protein interaction serve as a marker of albumin permeation from the release medium into the hydrogel.

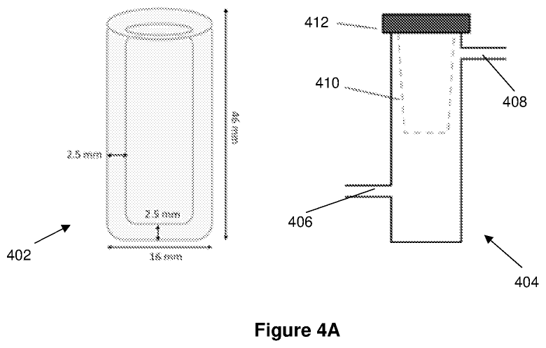

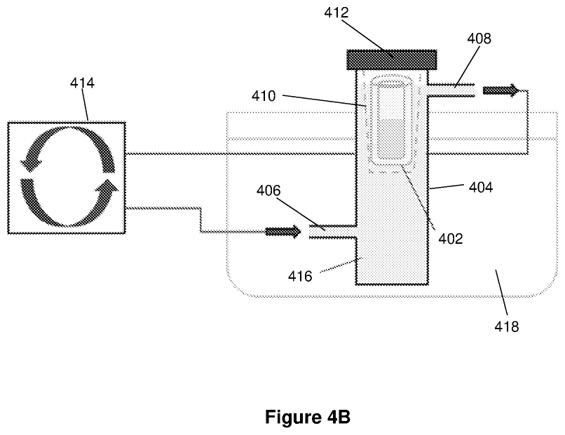

The first diffusion experiment involves testing a first hydrogel container (version 1.0) in an isolated environment as a proof-of-concept model. At step 302A, the container was tested with Actrapid® and Apidra® in PBS to assess the diffusion behaviour of the human soluble insulin, insulin glulisine and m-cresol present in the insulin formulations. At step 304A, a reference experiment was conducted without the hydrogel container to evaluate interaction of the insulin formulations with the pump equipment and to identify their potential loss inside the equipment. These steps are explained in further detail below with reference to FIGS. 4A and 4B.

The second diffusion experiment involves testing a second hydrogel container (version 2.0), which is an improved version of version 1.0. This second hydrogel container is exemplified in FIGS. 1A and 1B and is specifically designed and created for integration into the perfusion system of a USP apparatus IV.

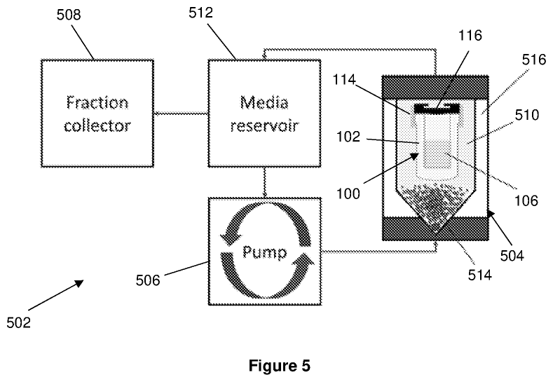

At step 302B, the container was tested for leaks using caffeine in PBS to assess the functionality of the cell inside the USP apparatus IV and the integrity of the hydrogel. At step 304B, the container was tested with Actrapid® and Apidra® in PBS to assess the diffusion behaviour of the human soluble insulin, insulin glulisine and m-cresol present in the insulin formulations. At step 306B, a reference experiment was conducted with the presence of the hydrogel container in the flow-through cell of the USP apparatus IV to evaluate interaction of the insulin formulations with the pump equipment and to identify their potential loss inside the equipment. At step 308B, the container was tested with Actrapid® and Apidra® in subcutaneous interstitial buffer (SIB) to assess the diffusion behaviour of the human soluble insulin, insulin glulisine and m-cresol present in the insulin formulations. At step 310B, the container is tested with Insulatard® in PBS to assess the diffusion behaviour of the insulin formulation. This is followed by adding heparin to Insulatard® to the trigger the release of insulin. These steps are explained in further detail below with reference to FIG. 5.

### Chemicals

Vials containing 10 ml of Actrapid® 100 IU/mL (equivalent to 3.5 mg regular human insulin/mL) and 10 ml of Insulatard® 100 IU/mL (equivalent to 3.5 mg isophane (NPH) insulin/mL) from Novo Nordisk A/S (Bagsværd, Denmark), as well as pre-filled pens of 3 mL Apidra® SoloSTAR® Pen 100 IU/mL (equivalent to 3.5 mg insulin glulisine/mL) from Sanofi (Paris, France) were purchased from the National University Hospital, Singapore. m-Cresol (99%) and caffeine reference standards were obtained from Sigma-Aldrich (Missouri, United States). Agarose (molecular biology grade) was obtained from Vivantis Technologies Sdn Bhd (Shah Alam, Malaysia). Buffer salt Na2HPO4·7H2O, KH2PO4, and KCl, were obtained from Avantor (Pennsylvania, United States). NaCl was obtained from VWR International (Pennsylvania, United States) and Tris base was obtained from Vivantis Technologies Sdn Bhd (Shah Alam, Malaysia). Tris HCl, CaCl2, MgSO₄·7H2O, CH3COONa and NaHCO₃, were obtained from Sigma-Aldrich (Missouri, United States). Hydrochloric acid was obtained from VWR International (Pennsylvania, United States). For the HPLC quantification, Methanol was obtained from Fisher Scientific (New Hampshire, United States) and acetonitrile was obtained from Avantor (Pennsylvania, United States). In regard to further additives, Polysorbate 80 (Tween 80), and heparin sodium salt from porcine intestinal mucosa (≥150 IU/mg) were obtained from Sigma-Aldrich (Missouri, United States). Purified water from a Milli-Q deionization unit was used for all the experiments.

### Preparation of Phosphate-Buffered Saline (PBS)

PBS was prepared using NaCl, KCl, Na₂HPO₄·7H₂O, and KH₂PO₄, with ion concentrations of 157 mM Na⁺, 4.5 mM K⁺, 140 mM Cl⁻, 10 mM HPO₄²⁻ (see Table 2 below). After adjustment to pH 7.4, the buffer was vacuum filtered through a 0.45 μm membrane. Following this was a modification of the deaeration method recommended by the USP as the buffer was heated to ˜40° C. and vigorously stirred for 5 min. For some setups, 0.01% (w/v) Tween 80 was added afterward to reduce adsorption to surfaces.

### Preparation of Subcutaneous Interstitial Buffer (SIB)

For the preparation of the more biorelevant media SIB, Tris base and Tris HCL were dissolved first. Then NaCl, Na₂HPO₄·7H₂O, KCL, KH₂PO₄, CH₃COONa, MgSO₄·7H₂O, and CaCl₂) were added, with NaHCO₃ being included at the very end to avoid precipitation of poorly soluble carbonate salts. Ion concentrations were 136 mM Na⁺, 3.9 mM K⁺, 1.3 mM Ca²⁺, 0.5 mM Mg²⁺, 114.9 mM Cl⁻, 20.6 HCO₃⁻, 1 mM HPO₄²⁻, 0.5 mM SO₄²⁻ (see Table 2 below). After adjustment to a pH of 7.4 at 34° C., the buffer was vacuum filtered through a 0.45 μm membrane. This is an important step as the pH of Tris is temperature-dependent. Next, the modified USP deaeration method was used where the buffer was heated to ˜40° C. and vigorously stirred for 5 min. The buffer was freshly prepared for every run, to avoid precipitation and pH changes over time.

TABLE 2

| | Cations [mM] | | | | Anions [mM] | | | | Proteins |
|---|---|---|---|---|---|---|---|---|---|
| | Na⁺ | K⁺ | Ca²⁺ | Mg²⁺ | Cl⁻ | HCO₃⁻ | HPO₄²⁻ | SO₄²⁻ | [g/L] |
| Blood | 142 | 5 | 2.5 | 1.5 | 103 | 27 | 1 | 0.5 | 60-80 |
| plasma | | | | | | | | | |
| Interstitial | 143 | 4 | 1.3 | 0.7 | 115 | 28 | 1 | 0.5 | 26 |
| fluid | | | | | | | | | |
| PBS | 157 | 4.5 | — | — | 140 | — | 10 | — | — |
| SBF | 142 | 5 | 2.5 | 1.5 | 148.8 | 4.2 | 1 | 0.5 | — |
| HBSS | 142.8 | 5.8 | 1.3 | 0.9 | 146.8 | 4.2 | 0.3 | 0.4 | — |
| SIB | 136 | 3.9 | 1.3 | 0.5 | 114.9 | 20.6 | 1 | 0.5 | — |
| SSIF | 136 | 3.9 | 1.3 | 0.5 | 114.9 | 20.6 | 1 | 0.5 | 25 (FBS) |

FBS = Fetal bovine serum;
HBSS = Hanks' balanced salts solution;
PBS = Phosphate buffered saline;
SBF= Simulated body fluid;
SIB = Subcutaneous interstitial buffer;
SSIF = Simulated subcutaneous interstitial fluid

Quantification of Insulin and m-Cresol

A Chromaster high-performance liquid chromatography (HPLC) system (VWR Hitachi, Tokyo, Japan) was used. The general setup included an HPLC pump (no. 5160), a column oven (no. 5310), an autosampler (no. 5260), and a UV-Vis detector (no. 5420). A Hypersil BDS C18 column with a dimension of 100×4.6 mm was used (Thermo Scientific, New Hampshire, USA). The mobile phase was composed of 30% acetonitrile and 70% water, both acidified with 0.1% TFA. Over 9 minutes the composition was gradually changed to 40% acetonitrile and 60% water before gradually returning to its initial values at 10 minutes. The mobile phase was pumped at a flow rate of 1 mL/min and the needle was washed with 30% of acetonitrile before each injection. All samples were diluted with mobile phase before measurement. The concentration of insulin in each sample was measured by detecting the absorbance of monochromatic light at a wavelength of 214 nm with an injection volume of 20 μL. A total run time of around 10 minutes was required with m-cresol peaks appearing at 4 min, while insulin peaks for Actrapid®, Apidra®, and Insulatard®, appeared after approximately 5 min.

### Quantification of Caffeine

Caffeine was quantified using the U-5100 UV/Visible spectrophotometer by Hitachi (Tokyo, Japan) at a 290 nm wavelength. A 50 μl quartz cuvette was chosen and samples were measured in triplicates without dilution.

### Proof-of-Concept Model

FIG. 4A illustrates a hydrogel container 402 (left) and a modified flow-through cell 404 (right) used as a proof-of-concept model for the diffusion experiment shown in the first flow chart 300A of FIG. 3. The proof-of-concept model was designed to affirm the discriminative power of an agarose hydrogel under continuous media flow. Serving as a physicochemical barrier between drug and media, it is supposed to generate data ascertaining differences in diffusion behaviour and gel interaction of closely related drug formulations. For this, Actrapid® (regular human insulin, hexamer) and Apidra® (insulin glulisine) were chosen as model peptide formulations for the initial setup. m-Cresol, present in both formulations, was quantified as well, serving as an internal standard.

A cylindrical gel that forms both the physicochemical barrier and pocket was prepared with the help of custom-made plastic receptacles. The gel consists of 2% (w/w) agarose dissolved in PBS. After heating the gel to the boiling point, under constant stirring, a homogenous mixture was obtained. Evaporated water was subsequently replenished. The hot mixture was poured into the cylindrical plastic receptacles and an inner cylindrical plastic punch was inserted, forming the pocket, where the drug formulation will be dispensed. After cooling at room temperature, the gel is formed and ready to use. The hydrogel container 402 with a gel thickness of approximately 2.5 mm was produced.

Roughly inspired by flow-through cells of a USP apparatus IV, modified flow-through cells 404 were prepared from 50 mL centrifuge tubes (115 mm×30 mm×30 mm). An inlet port 406 and an outlet port 408 were created from Luer lock syringe needles after respective holes were drilled into the tube. The Luer lock syringe needles for the upper outlet port 408 were capped with a wire cutter, while the needle tips intended for the lower inlet port 406 were bent to direct inflowing fluids towards the bottom of the falcon tube, from where the media could flow in an upwards stream towards the outlet port 406. The inserted needles were further fixed with silicone sealant, thread seal tape, and parafilm to prevent leaks. To ensure that the drug formulation inside the prepared gel pocket does not come into direct contact with the media, a stainless-steel wire cage 410 was created. The cage 410 was fixed at a height where the inserted gel had its opening above the upper outlet port 408. Due to the media level inside the modified flow-through cell 404 not rising above the upper outlet port 408, the drug formulation was separated from the media and had to choose the pathway through the hydrogel container 402. The modified flow-through cell 404 further includes a cap 412 to prevent accidental spills from the cell 404.

FIG. 4B illustrates an assay setup for the proof-of-concept model of FIG. 4A for in vitro drug testing. A continuous medium flow was achieved by connecting the modified flow-through cells 404 with a CP7-35 Piston Pump 414 (Sotax AG, Basel, Switzerland). Luer lock adapters allowed the standard ¼″-28 UNF threads to be connected to the custom-made cells 404. At the selected flow rate (8±0.4 mL/min for this setup), 50 mL of PBS media 416 with 0.01% (w/v) Tween 80 was pumped through the flow-through cells 404 in a closed-loop setting. The cells 404 were placed into a water bath 418 to raise the media temperature to 37°±0.5 C. To purge the tubes from air bubbles and raise the temperature, media was pumped through the cells 404 for at least 30 minutes. Once the desired temperature was reached, 1.5 mL of either Actrapid® or Apidra® (equivalent to 150 IU or 5.25 mg of insulin) were injected into the gel pocket and subsequently placed into the cage 410. Samples with a volume of 0.2 mL of medium were collected manually every hour during the first 7 hours before it was replenished with fresh medium. Quantification of insulin and m-cresol in the medium was then carried out by HPLC. Subsequently, the cumulative diffusion of the model drugs was calculated by comparing the diffused amount with the initially added drug concentration.

A reference experiment was subsequently conducted by adding insulin to the medium. This was to identify a potential degradation or adsorption of insulin in the perfusion system. All experiments were conducted in triplicates.

FIG. 5 illustrates an assay setup of the hydrogel container 100 in the USP apparatus IV 502 for the diffusion experiment shown in the second flow chart 300B of FIG. 3. To further improve and develop the diffusion assay in line with internationally recognized standards, the hydrogel container 100 was created for the integration into USP apparatus IV 502. The compendial flow-through cell 504 of the USP apparatus IV 502 is an enclosed system with a heating mantle that allows a controlled medium flow from the bottom to the top of the cell 504.

Multiple versions were created before the design of current hydrogel container 100 was finalized. Fusion 360™ modelling software (Autodesk, California, USA) was used for the initial sketches of a 3D-printed ring 114 serving as a gel holder.

For the fabrication of the ring 114 of the container 100, the stereolithography (SLA) printer Form 2™ (Formlabs, Massachusetts, USA) was used with a HighTemp V2™ resin (Formlabs, Massachusetts, USA). This specific resin was selected due to its high heat deflection and good compatibility with aqueous solvents. A layer thickness of 0.050 mm guaranteed high resolution and required roughly 3 hours of printing time with the usual printing support structures added. After printing the ring 114, they were washed with isopropanol for 15 minutes and treated in the Asiga Flash™ curing station (Asiga, Alexandria, Australia) under UV light for several hours. The printed rings 114 proved to be very durable and chemically resistant.

The ring 114 was mounted onto a cylindrical mould and the gel composition was filled into the mould. A punch was used to create interior pockets of similar size. The drug formulation 106 was then injected into the interior pocket of the receptacle 102, and the ring 114 was sealed with a rubber plug 116.

The USP apparatus IV 502, as well as the various flow-through cells 504, have been described by various pharmacopoeias and related literature. For this diffusion experiment, a SOTAX CP7-35 Piston Pump 506, alone with a fraction collector 508 and the SOTAX CE7 dissolution system, was used. Media 510 was filled into the reservoir 512 with magnetic stirrers running at 150 rpm. The dissolution apparatus was operated in a closed-loop configuration with a constant flow of 8±0.4 mL/min for all experiments. Before the flow-through cells 504 with 22.6 mm inner diameter were inserted, the system was set to a by-pass mode purging the air from the capillaries.

A single 5 mm ruby glass sphere and approximately 2.4 g of glass beads 514 of 1 mm diameter were filled into the flow-through cells 504 to guarantee laminar flow. The heating jacket 516 maintained the temperature closer to what can be found in the subcutaneous tissue with 34° C.±0.5 for all setups. The freshly prepared containers 100 were injected with the respective drug formulations 106, sealed with a rubber plug 116, and carefully placed on top of the glass beads 514. Afterwards, the flow-through cells 504 were assembled and placed in the main system.

The diffusion experiments were initiated with a caffeine stock solution (4 mg/mL) in the container 100 to evaluate the functionality of the new setup and the integrity of the hydrogel. A medium volume of 100 mL of PBS 510 was selected. The initial injection volume of test drug was 1 mL. The run was conducted over 8 hours, and samples are collected with a volume of 0.5 mL after 0.5, 0.75, 1, 1.25, 1.5, 1.75, 2, 2.25, 2.75, 3.25, 3.75, 4.25, 5.25, 6.25, and 8.25 hours. The medium 510 was not replenished. Caffeine was quantified with a ultraviolet-visible (UV/Vis) spectrometer. Subsequently, the cumulative diffusion of caffeine was calculated by comparing the diffused amount with the initially added drug concentration. All experiments were carried out in triplicates.

In the next step, new containers 100 were evaluated with Actrapid® and Apidra®. This was to evaluate the capability of the assay to discriminate between the compounds which differ in their molecular size. Volumes of 60 mL of PBS or SIB 510 were used, respectively. Again, 1 mL of each formulation 106 was injected into the receptacles 102. Samples with a volume of 0.5 mL were collected after 2, 4, 6, 8, 12, 16, 20, and 24 hours. The medium 510 was not replenished. Quantification of insulin and m-cresol was accomplished by HPLC. Subsequently, the cumulative diffusion of insulin and m-cresol were calculated by comparing the diffused amount with the initially added drug amount.

In a subsequent reference experiment, both insulins were added to the acceptor medium 510 with the container 100 present to investigate the adsorption and degradation (recovery) of insulin over time. All experiments were conducted in triplicates.

Insulatard® is a depot formulation of insulin. The suspension comprises microcrystalline insulin in presence of zinc and protamine. The performance test was carried out under the conditions described previously (using PBS as the release medium 510). In a follow-up investigation, an excess of heparin sodium salt (1 mg per mL) was added to the formulation 106. Heparin serves as a complexing agent that triggers the release of insulin by forming a heparin-protamine complex.

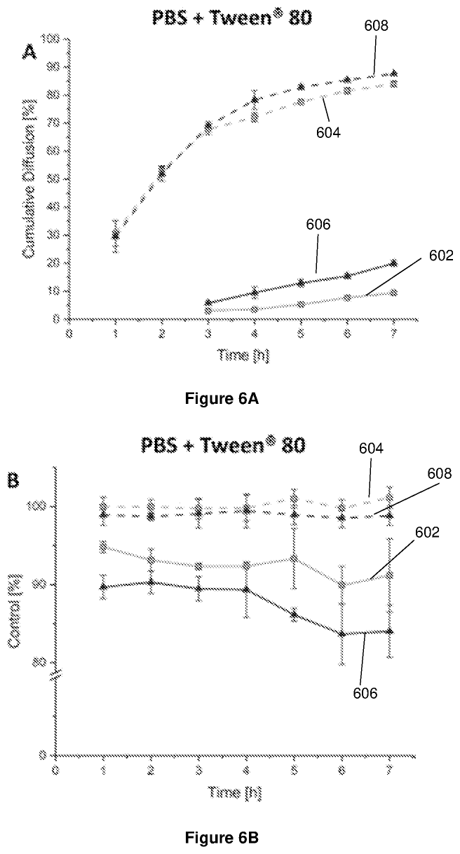

FIG. 6A illustrates a line graph depicting the diffusion profile of Actrapid® and Apidra® in the experiment explained above, with reference to FIGS. 4A and 4B. FIG. 6B illustrates a line graph depicting the outcome of the reference experiment explained above, with reference to FIGS. 4A and 4B. The horizontal axis represents time in hours, and the vertical axis represents the concentration of the components of the formulations in percentage (%). The first line 602 represents data for regular human insulin from Actrapid®, the second line 604 represents data for m-cresol from Actrapid®, the third line 606 represents data for insulin glulisine from Apidra®, and the fourth line 608 represents data for m-cresol from Apidra®.

With this proof-of concept model, the first experiment investigated the diffusion of Actrapid® and Apidra® in PBS supplemented with 0.01% (w/v) Tween 80. HPLC analysis allows the quantification of insulin (regular human insulin and insulin glulisine), as well as m-cresol. The cumulative diffusion was calculated as the percentage of the injected dose (FIG. 6A). To quantify the significance of the displayed differences in diffusion behaviour, the difference factor (f1) and the similarity factor (f2) were calculated. The f1 and f2 factors were developed by Moore and Flanner before it was adopted by FDA guidelines for immediate-release solid oral dosage forms. Two release profiles become more similar the closer the f1 factor is to zero and the higher the calculated f2 factor is. To avoid any ambiguity during scale-up and post-approval changes, a limit of ≤15 for f1 and >50 for f2 was proposed by the FDA to conclude that the release of two selected formulations is similar. The FDA specified several criteria that have to be met before calculation and a few did not apply to the current setup, like at least 12 individual dosage forms for both products have to be tested.

The diffusion profiles of Actrapid® and Apidra® exhibited an increase in cumulative diffusion for both insulin and m-cresol over time with both insulins being first detected after 3 hours. Regular human insulin from Actrapid® peaked at 9.4±0.2% at 7 h, while the diffusion of insulin glulisine from Apidra® happened at a higher rate with 20±1.0% at 7 h (f1=119, f2=56). The f1 factor concludes a significant difference, while the f2 factor would have deemed both profiles to be similar if the FDA-given thresholds are considered. In this case, where only one factor reaches the given limits, the two formulations will be deemed as dissimilar, crediting the ability of the assay to discriminate between both insulin formulations.

Meanwhile, their m-cresol counterparts diffused at a much faster rate, both approximately reaching their plateau at 7 h. The m-cresol inside the Actrapid® formulation seemingly diffused towards a smaller plateau at 84±1.0%, while the m-cresol inside Apidra® reached a maximum at 88±0.2%, but the difference was not significant (f1=5, f2=71).

Furthermore, a reference experiment was conducted where the pure formulation was injected into the medium (FIG. 6B). The experiment presented a slight decrease in the insulin concentration over time, indicating adsorption or degradation processes that reduce the recovery from 95±0.7% after 1 h to 91±4.7% after 7 h for regular human insulin in Actrapid®, and 90±1.5% after 1 h to 84±3.3% after 7 h for insulin glulisine in Apidra®. Meanwhile, both m-cresol profiles fluctuated around 100±1.8%. The recovery profiles of both insulins and m-cresol respectively are significantly similar (insulins: f1=5, f2=64; m-cresol: f1=1, f2=88).

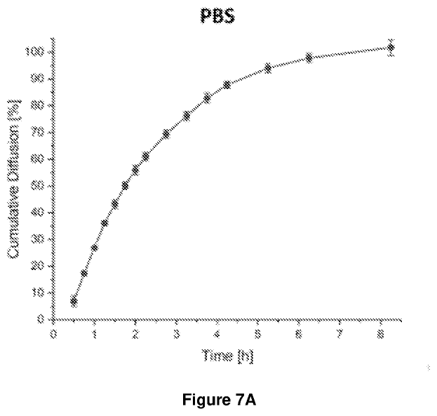

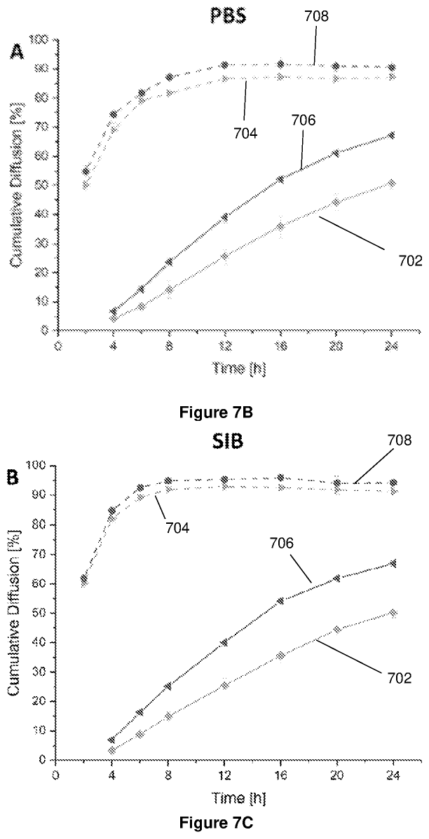

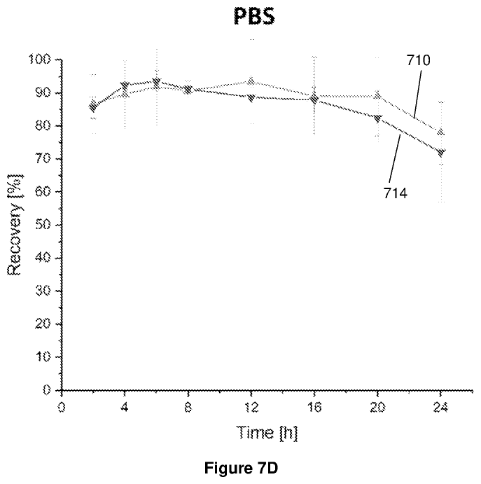

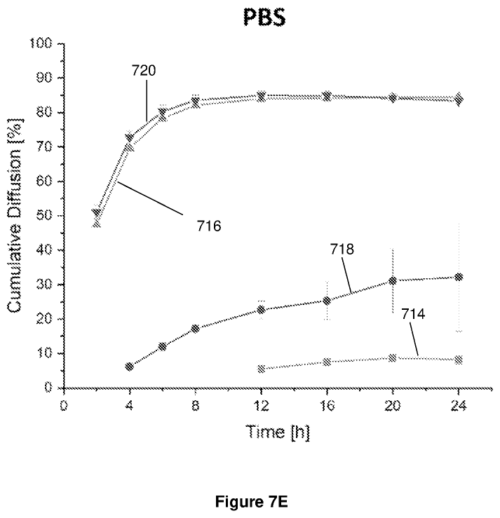

FIG. 7A illustrates a line graph depicting the diffusion profile of a caffeine stock solution in the experiment explained above, with reference to FIG. 5. Initially, caffeine was used as a small-molecular and stable model compound. An experiment in PBS over 8 h resulted in a steady increase of the drug concentration in the acceptor compartment, where caffeine slowly diffused through the gel of the container 100, culminating at around 101±3% at 8.25 h.

FIG. 7B illustrates a line graph depicting the diffusion profile of Actrapid® and Apidra® in PBS solution 510 in the experiment explained above, with reference to FIG. 5. FIG. 7C illustrates a line graph depicting the diffusion profile of Actrapid® and Apidra® in SIB solution 510 in the experiment explained above, with reference to FIG. 5. The horizontal axis represents time in hours, and the vertical axis represents the concentration of the components of the formulations in percentage (%). The first line 702 represents data for regular human insulin from Actrapid®, the second line 704 represents data for m-cresol from Actrapid®, the third line 706 represents data for insulin glulisine from Apidra®, and the fourth line 708 represents data for m-cresol from Apidra®.

Actrapid® and Apidra® were tested in PBS, as well as in the more biorelevant SIB, at the specified conditions. Similar to the test results found in the proof-of-concept study, hexameric human insulin (Actrapid®) diffused at a slower rate as compared to monomeric insulin glulisine (Apidra®) during the first hours. In PBS and SIB, insulin diffused at the same rate and was first detected after 4 h. The experiments were carried out over 24 h without any visible changes in the integrity of the hydrogel. In PBS, insulin glulisine reached 67±0.2% and diffused at a faster rate than regular human insulin which peaked at 50±4% (f1=44, f2=45).

With the hydrogel container 100, both f-factors were calculated and found to be outside the given thresholds, thus, irrefutably indicating that both profiles are significantly dissimilar. Their internal standards reached their plateau at a similar rate indicating no significant loss of media 510 through leaks in the USP IV 502 over the entire run. Comparatively, the testing in SIB 510 led to almost the same results (regular insulin: f1=2, f2=97; insulin glulisine: f1=3, f2=89) with both f1 and f2 tests agreeing with its significance. In SIB, insulin glulisine peaked at 67±1.4% after 24 h, while regular human insulin peaked at a slower rate with 50±3.2% (f1=49, f2=43). m-Cresol reached a stable plateau here as well.

FIG. 7D illustrates a line graph depicting the outcome of the reference experiment explained above, with reference to FIG. 5. The first line 710 represents data for regular human insulin from Actrapid®, and the second line 712 represents data for insulin glulisine from Apidra®.

The reference experiment was conducted where Actrapid® and Apidra® were injected directly into the acceptor media 510 inside the flow-through cell 504. The hydrogel container 100 was placed in the setup as well to ascertain that interactions in the presence of the agarose hydrogel are covered by the recovery study. The recovery of both insulins in PBS 510 is presented in FIG. 7D. A small but considerable loss of insulin was detected for both cases with 78±12% of regular insulin and 72±24% of insulin glulisine being recovered after 24 h. The standard deviations are quite large compared to the usual diffusion run. It can be assumed that insulin diffused into the gel present in this reference experiment, therefore not reaching 100% recovery.

FIG. 7E illustrates a line graph depicting the diffusion profile of Insulatard® and Insulatard® treated with heparin in PBS solution 510 in the experiment explained above, with reference to FIG. 5. The first line 714 represents data for insulin from untreated Insulatard®, the second line 716 represents data for m-cresol from untreated Insulatard®, the third line 718 represents data for insulin from treated Insulatard®, and the fourth line 720 represents data for m-cresol from treated Insulatard®.

Insulatard® is an isophane (NPH) human insulin suspension. Without further treatment, only 5.5±3.8% of insulin were detected after 12 h with no considerable increase afterwards. To release the insulin from the suspension, an excess of heparin was added in a follow-up experiment. The diffusion curve more resembles the one of hexameric human insulin as it reaches its peak at 32±49% after 24 h, though the similarity is not deemed significant enough with the given standard deviations. The m-cresol standard reached its stable plateau without any issues.

The initial proof-of-concept study (version 1.0) reflected the expected ranking order with hexameric insulin diffusing slower than insulin glulisine. Actrapid® comprises zinc, a cation that stabilizes the hexameric state, meanwhile, insulin glulisine (Apidra®) is engineered to reduce the formation of oligomers. The assembly of hexamers is reduced by two amino acid substitutions. The sequence of human insulin has been changed in B3 (asparagine is replaced by lysine), and B29 position (lysine is replaced by glutamic acid). Additionally, Apidra® does not contain zinc. Due to the differences in molecular weight, the molecular mobilities and absorption rates are expected to be faster for the monomers as compared to dimers and hexamers. Evidently, insulin glulisine is advertised as rapid-acting insulin, displaying faster absorption in vivo.

m-Cresol was quantified as well to detect potential errors arising from gel preparation. Since m-cresol is a stable and small molecule, it was observed that they diffused more rapidly compared to the two larger insulin molecules, in accordance with expectations. Also, the high recovery indicates that there is no leakage from the perfusion cycle. Still, m-cresol is known for unspecific interactions with proteins and present excipients. This could explain the release profile of m-cresol plateauing at different levels for Actrapid® and Apidra® as their compositions differ slightly. A change in the barrier properties due to interactions of hexameric insulin with the hydrogel could influence the diffusion of m-cresol as well. Therefore, evaluating the diffusion with another small-molecular compound in the future was considered a useful addition to the characterization. A similar diffusion behaviour would exclude the possibility of a change in the hydrogel structure.

The reference experiments hinted at a loss or degradation of insulin over time. With lots of hydrophobic surfaces present, insulin, in its monomeric form especially, will adsorb onto said surfaces leading to aggregation and finally to denaturation. Due to the insulin being directly injected into the media all at once, a lot of insulin came into contact with these surfaces much quicker than in a normal run. The adsorption onto said surfaces could explain why both insulins are never fully recovered, even at earlier sample points. Also, the primarily monomeric insulin glulisine seems to be more easily lost as well, again supporting the adsorption of monomeric insulin. Further experiments might see the inclusion of higher concentrations of other surfactants like Tween 20.

As outlined in the previous sections, an integration of the hydrogel container 100 into USP apparatus IV 502 was achieved, and a fraction collector enables automation of the release experiments, eliminating any human sampling error that was more pronounced in the experiment involving the proof-of-concept model. The initial experiments with caffeine confirmed a highly consistent and reproducible diffusion behaviour with low standard deviations. Caffeine has been used as a marker molecule for the characterization of agarose gels earlier and exhibits a very low plasma protein binding.

With the USP apparatus IV 502 and the hydrogel container 100, the results of the initial design were successfully reproduced. In fact, the hydrogel container 100 displayed an even more pronounced discriminative power. The difference in the rate and extent of the measured diffusion behaviour was more significant.

A comparison between the release tests carried out in SIB and PBS indicated no significant influence of the medium on the diffusion behaviour. The ion composition did not affect the permeation of the insulins. This might change with different gel compositions as these tests were conducted with pure agarose gels only. The last experiment was dedicated to the evaluation of a more complex drug formulation in the hydrogel container 100. Insulatard® is a microcrystalline suspension of insulin in presence of protamine and zinc. Protamine, in a physiological setting, is broken down by enzymes in the subcutaneous tissue, consequently releasing the hexameric insulin from its complex. Alternatively, the release can be triggered in vitro. An excess of heparin was used to form stable complexes with protamine resulting in the release of hexameric insulin. Future experiments might consider the addition of enzymes like trypsin to reach higher levels of biorelevance.

Overall, the hydrogel container 100 provides a reliable setup with optimal properties for further testing of compounds in the USP apparatus IV. High sensitivity, reproducibility and the capability to discriminate between different formulations have been achieved.

Based on the reported observations, the biopredictiveness of the assay can be systematically evaluated and optimized. To understand the in vitro conditions in donor and acceptor compartments and to address technical challenges arising from drug degradation through the shearing and adsorption of proteins, diffusion processes in the USP apparatus IV can be modelled using computational fluid dynamics (CFD) or other suitable software.

Biopredictiveness is achieved through a systematic evaluation of the changes in the in vitro diffusion rates observed in response to changes in gel and medium composition, together with repeated benchmarking against the absorption rates observed in vivo. To this end, an in vitro in vivo correlation (IVIVC) can be established, correlating the collected in vitro data with observed in vivo responses. Initially, the pharmacokinetic profiles reported for subcutaneously formulations will be analysed using the MonolixSuite™ 2021 (Lixoft, Zug, Switzerland). To design a suitable in silico model allowing simulations, Stella Architect™ can be used (isee systems, New Hampshire, USA). In order to improve the level of biorelevance, the gel can be modified, for instance, using components of the extracellular matrix such as collagen, peptone, and hyaluronic acid. The medium will further be supplemented with serum proteins that are known to have a stabilizing effect on other proteins.

It will be appreciated by a person skilled in the art that numerous variations and/or modifications may be made to the present invention as shown in the specific embodiments without departing from the scope of the invention as broadly described. The present embodiments are, therefore, to be considered in all respects to be illustrative and not restrictive.

1. A container for in vitro drug testing, the container comprising:
a receptacle having a wall, wherein the receptacle has an opening and is configured to receive a drug formulation through the opening, and wherein the wall is made of a gel composition.

2. The container as claimed in claim 1, wherein a concentration of the gel composition is selected to simulate one or more properties of tissue.

3. The container as claimed in claim 1, wherein the gel composition comprises one or more polysaccharides selected from a group comprising agarose and hyaluronic acid.

4. The container as claimed in claim 3, wherein the gel composition comprises 0-5% by weight of agarose gel.

5. The container as claimed in claim 3, wherein the gel composition comprises 0-3% by weight of hyaluronic acid.

6. The container as claimed in claim 1, wherein the gel composition comprises one or more polypeptides selected from a group comprising collagen, gelatine and peptone.

7. The container as claimed in claim 6, wherein the gel composition comprises 0-1% by weight of collagen.

8. The container as claimed in claim 6, wherein the gel composition comprises 0-5% by weight of gelatine.

9. The container as claimed in claim 1, wherein the gel composition comprises one or more lipids selected from triglycerides and phospholipids.

10. The container as claimed in claim 1, wherein the gel composition comprises ions.

11. The container as claimed in claim 1, wherein the gel composition comprises vesicles.

12. The container as claimed in claim 1, wherein the gel composition comprises serum proteins.

13. The container as claimed in claim 1, further comprising a plug for sealing the opening of the receptacle.

14. The container as claimed in claim 1, further comprising a ring encircling a periphery of the opening of the receptacle for an injection of the drug formulation into the receptacle.

15. The container as claimed in claim 14, wherein the ring comprises a chemically inert material.

16. (canceled)

17. The container as claimed in claim 14, wherein the ring comprises an inner wall and a collar encircling the inner wall adjacent a base of the ring, creating a recess to accommodate the periphery of the opening of the receptacle.

18. The container as claimed in claim 14, wherein the ring comprises an inner wall and a textured area encircling the inner wall adjacent a top of the ring.

19. A method for preparing a container for in vitro drug testing, the method comprising the steps of:
forming a receptacle having a wall, wherein the wall comprises a gel composition; and
disposing a drug formulation into the receptacle.

20. The method as claimed in claim 19, wherein forming the receptacle comprises the steps of:
attaching a ring to a mold;
pouring the gel composition into the mold; and
inserting an inner punch to the gel composition to form the receptacle such that the ring encircles a periphery of an opening of the receptacle.

21. (canceled)

22. A testing method comprising:
disposing a drug formulation in a container according to claim 1;
immersing the container into a media inside a US pharmacopeia (USP) IV flow-through cell; and
monitoring diffusion of the drug formulation between the container and the media.
